(19) United States
(12) Patent Application Publication
(10) Pub. No.: US 2011/0186638 A1
(43) Pub. Date: Aug. 4, 2011

(54) DATA READER, DATA READING METHOD AND DATA RECORDER

(75) Inventor: Kazuhisa FUNAMOTO, Kanagawa (JP)

(73) Assignee: Sony Corporation, Tokyo (JP)

(21) Appl. No.: 12/980,941

(22) Filed: Dec. 29, 2010

(30) Foreign Application Priority Data
Feb. 3, 2010 (JP) 2010-022373

(51) Int. Cl. G06K 7/12; G06K 19/06

(52) U.S. Cl. 235/469; 235/494

(57) ABSTRACT

Disclosed herein is a data reader including: an image acquisition section configured to acquire an image having color cells arranged in a two-dimensional space, each of the color cells being made up of a graphic of a given color density in a predetermined form and size; a spatial deinterleaving section configured to perform spatial deinterleaving adapted to sort the color cells arranged in the two-dimensional space in a spatially distributed manner in the acquired image; and a color decoding section configured to decode data coded in association with colors of the color cells and densities of the colors by analyzing the image with the sorted color cells as color data associated with coordinate positions in the two-dimensional space.

### BACKGROUND OF THE INVENTION

1. Field of the Invention

The present invention relates to a data reader, data reading method and data recorder, and more particularly, to a data reader, data reading method and data recorder for providing improved reliability of recorded content and achieving higher recording capacity in a data recording scheme designed to record digital data, for example, by printing or displaying such data.

2. Description of the Related Art

Recent years have seen widespread use of the barcode, QR code and other two-dimensional codes to record digital data on paper and other media by printing. In such a recording scheme, tags are often used to manage merchandise and other materials thanks to an extremely low recording cost.

The use of the barcode, QR code or other code in public relations media designed to be read by mobile phone cameras is also rapidly becoming popular in recent years.

The barcode, QR code and other code techniques are extremely useful as digital recording techniques achievable at low cost on one hand. On the other hand, their low recording capacity has been a problem that is yet to be solved. For example, even the QR code that records information two-dimensionally can record only up to 7089 letters (if only numbers are recorded). In order to find wider areas of application in the future, the barcode and other recording schemes must offer higher recording capacity.

Possible solutions to achieve higher recording capacity with the barcode would be to color the barcode and downsize it to an extremely small size. The barcode and QR code normally record information in a binary fashion of black and white. However, if the barcode is colored with a plurality of colors rather than two colors of black and white, more information can be recorded on the same area. Further, if the units in which to record information (hereinafter referred to as a cell) are reduced to be small, more information can also be recorded on the same area.

On the other hand, a technique has been proposed that is designed to stack readable two-dimensional codes, each having information recorded therein, one on top of another so as to generate another readable two-dimensional code (refer, for example, to Japanese Patent

### SUMMARY OF THE INVENTION

However, coloring the barcode or downsizing it to an extremely small size entails difficulties in recording or reading data.

In the case of color printing, for example, a printed matter may fade over time. That is, fading to an extent not problematic for black and white binary recording may result in non-reproducible data for the color barcode. In order to find wider areas of application, a data recording scheme is required that can properly reproduce data even in the presence of such fading.

On the other hand, if data to be recorded is printed, for example, on paper, the paper surface is prone to local smudges and scratches despite efforts to preserve the surface carefully. Data damaged by such smudges and scratches is difficult to recover retrospectively.

The present invention has been made in light of the foregoing, and it is an aim of the present invention to provide improved reliability of recorded content and achieve higher recording capacity in a data recording scheme designed to record digital data, for example, by printing and displaying such data.

A first mode of the present invention is a data reader that includes image acquisition means, spatial deinterleaving means and color decoding means. The image acquisition means acquires an image having color cells arranged in a two-dimensional space. Each of the color cells is made up of a graphic of a given color density in a predetermined form and size. The spatial deinterleaving means performs spatial deinterleaving adapted to sort the color cells arranged in the two-dimensional space in a spatially distributed manner in the acquired image. The color decoding means decodes data coded in association with colors of the color cells and densities of the colors by analyzing the image with the sorted color cells as color data associated with coordinate positions in the two-dimensional space.

The spatial deinterleaving means can sort the color cells arranged in a spatially distributed manner through hierarchical random interleaving.

The color data associated with the coordinate positions in the two-dimensional space is multiplexed data obtained by multiplexing a plurality of data elements. The color decoding means can separate the multiplexed data into the data elements.

The plurality of data elements can be multiplexed by dividing the two-dimensional space in which the image is displayed.

The plurality of data elements can be multiplexed with frequencies associated with changes in color of the color cells in the two-dimensional space in which the image is displayed.

The plurality of data elements can be multiplexed by combining a plurality of colors on the same color cell.

The data reader may further include control information decoding means adapted to decode control information made up of a graphic in a predetermined color, form and size that is displayed at a predetermined position of the two-dimensional space in which the image is displayed. This allows for the deinterleaving and color decoding to be performed based on information contained in the control information.

The data reader may further include equalization means operable to perform equalization adapted to correct the colors of the color cells based on the color of a pilot made up of a graphic in a predetermined color, form and size that is displayed at a predetermined position of the two-dimensional space in which the image is displayed.

The first mode of the present invention is a data reading method that includes a step of using image acquisition means to acquire an image having color cells arranged in a two-dimensional space. Each of the color cells is made up of a graphic of a given color density in a predetermined form and size. The data reading method further includes a step of using spatial deinterleaving means to perform spatial deinterleaving adapted to sort the color cells arranged in the two-dimensional space in a spatially distributed manner in the acquired image. The data reading method still further includes a step of using color decoding means to decode data coded in association with colors of the color cells and densities of the colors by analyzing the image with the sorted color cells as color data associated with coordinate positions in the two-dimensional space.

The first mode of the present invention is a program that causes a computer to function as a data reader. The data reader includes image acquisition means, spatial deinterleaving means and color decoding means. The image acquisition means acquires an image having color cells arranged in a two-dimensional space. Each of the color cells is made up of a graphic of a given color density in a predetermined form and size. The spatial deinterleaving means performs spatial deinterleaving adapted to sort the color cells arranged in the two-dimensional space in a spatially distributed manner in the acquired image. The color decoding means decodes data coded in association with colors of the color cells and densities of the colors by analyzing the image with the sorted color cells as color data associated with coordinate positions in the two-dimensional space.

In the first mode of the present invention, an image is acquired that has color cells arranged in a two-dimensional space. Each of the color cells is made up of a graphic of a given color density in a predetermined form and size. The color cells are sorted that are arranged in the two-dimensional space in a spatially distributed manner in the acquired image. Data is decoded that has been coded in association with colors of the color cells and densities of the colors by analyzing the image with the sorted color cells as color data associated with coordinate positions in the two-dimensional space.

A second mode of the present invention is a data recorder that includes color coding means, spatial interleaving means and recording means. The color coding means codes input digital data in association with colors and densities of the colors. The spatial interleaving means performs spatial interleaving adapted to sort data, coded in association with the colors and color densities, in a spatially distributed manner during arrangement of the data in a two-dimensional space. The recording means records the input digital data by displaying the spatially interleaved data as color cells in the two-dimensional space. Each of the color cells is made up of a graphic of a given color density in a predetermined form and size.

In the second mode of the present invention, input digital data is coded in association with colors and densities of the colors. Spatial interleaving is performed to sort data, coded in association with the colors and the densities of the colors, in a spatially distributed manner during arrangement of the data in a two-dimensional space. The input digital data is recorded by displaying the spatially interleaved data as color cells in the two-dimensional space. Each of the color cells is made up of a graphic of a given color density in a predetermined form and size.

A third mode of the present invention is a data reader that includes image acquisition means, equalization means and color decoding means. The image acquisition means acquires an image having color cells arranged in a two-dimensional space. Each of the color cells is made up of a graphic of a given color density in a predetermined form and size. The equalization means performs equalization to correct the colors of the color cells based on the color of a pilot made up of a graphic in a predetermined color, form and size that is displayed at a predetermined position of the two-dimensional space in which the image is displayed. The color decoding means decodes data coded in association with colors of the color cells and densities of the colors by analyzing the image with the corrected colors of the color cells as color data associated with coordinate positions in the two-dimensional space.

The color data associated with the coordinate positions in the two-dimensional space is multiplexed data obtained by multiplexing a plurality of data elements. The color decoding means can separate the multiplexed data into the data elements.

The plurality of data elements can be multiplexed by dividing the two-dimensional space in which the image is displayed.

The plurality of data elements can be multiplexed with frequencies associated with changes in color of the color cells in the two-dimensional space in which the image is displayed.

The plurality of data elements can be multiplexed by combining the plurality of color cell colors.

The data reader may further include control information decoding means adapted to decode control information made up of a white or black graphic in a predetermined form and size that is displayed at a predetermined position of the two-dimensional space in which the image is displayed. This allows for the equalizing and color decoding to be performed based on information contained in the control information.

The third mode of the present invention is a data reading method that includes a step of using image acquisition means to acquire an image having color cells arranged in a two-dimensional space. Each of the color cells is made up of a graphic of a given color density in a predetermined form and size. The data reading method further includes a step of using equalization means to perform equalization so as to correct the colors of the color cells based on the color of a pilot made up of a graphic in a predetermined color, form and size that is displayed at a predetermined position of the two-dimensional space in which the image is displayed. The data reading method further includes a step of using color decoding means to decode data coded in association with colors of the color cells and densities of the colors by analyzing the image with the corrected colors of the color cells as color data associated with coordinate positions in the two-dimensional space.

The third mode of the present invention is a program that causes a computer to function as a data reader. The data reader includes image acquisition means, equalization means and color decoding means. The image acquisition means acquires an image having color cells arranged in a two-dimensional space. Each of the color cells is made up of a graphic of a given color density in a predetermined form and size. The equalization means performs equalization to correct the colors of the color cells based on the color of a pilot made up of a graphic in a predetermined color, form and size that is displayed at a predetermined position of the two-dimensional space in which the image is displayed. The color decoding means decodes data coded in association with colors of the color cells and densities of the colors by analyzing the image with the corrected colors of the color cells as color data associated with coordinate positions in the two-dimensional space.

In the third mode of the present invention, an image is acquired that has color cells arranged in a two-dimensional space. Each of the color cells is made up of a graphic of a given color density in a predetermined form and size. Equalization is performed to correct the colors of the color cells based on the color of a pilot made up of a graphic in a predetermined color, form and size that is displayed at a predetermined position of the two-dimensional space in which the image is displayed. Data is decoded that has been coded in association with colors of the color cells and densities of the colors by analyzing the image with the corrected colors of the color cells as color data associated with coordinate positions in the two-dimensional space.

A fourth mode of the present invention is a data recorder that includes color coding means, pilot insertion means and recording means. The color coding means codes input digital data in association with colors and densities of the colors. The pilot insertion means inserts data of a pilot into the coded data so that the pilot is inserted during arrangement of an image of the color densities in a two-dimensional space based on the coded data. The pilot is displayed at a predetermined coordinate position as a graphic of a given color density in a predetermined form and size. The recording means records the input digital data by displaying, in the two-dimensional space, the coded data having the data of the pilot inserted thereinto as an image that includes color cells and the pilot. Each of the color cells is made up of a graphic of a given color density in a predetermined form and size.

In the fourth mode of the present invention, input digital data is coded in association with colors and densities of the colors. Data of a pilot is inserted into the coded data so that the pilot is inserted during arrangement of an image of the color densities in a two-dimensional space based on the coded data. The pilot is displayed at a predetermined coordinate position as a graphic of a given color density in a predetermined form and size. The input digital data is recorded by displaying, in the two-dimensional space, the coded data having the data of the pilot inserted thereinto as an image that includes color cells and the pilot. Each of the color cells is made up of a graphic of a given color density in a predetermined form and size.

The present invention provides improved reliability of recorded content and achieves higher recording capacity in a data recording scheme designed to record digital data, for example, by printing or displaying such data.

### BRIEF DESCRIPTION OF THE DRAWINGS

FIG. 1 is a diagram describing an example of a data recording scheme to which an embodiment of the present invention is applied;

FIG. 2 is a diagram illustrating a configuration example of color cells;

FIG. 3 is a block diagram illustrating a configuration example of a data recorder according to an embodiment of the present invention;

FIG. 4 is a diagram describing an example of blocking;

FIG. 5 is a diagram describing an example of spatial multiplexing;

FIG. 6 is a diagram describing an example of frequency multiplexing;

FIG. 7 is a block diagram illustrating a detailed configuration example of a color mapping section shown in FIG. 3 when data is frequency-multiplexed;

FIG. 8 is a diagram describing an example of hierarchical multiplexing;

FIG. 9 is a diagram describing random interleaving;

FIG. 10 is a diagram describing recurrent random interleaving;

FIG. 11 is a block diagram illustrating a configuration example of a data reader according to an embodiment of the present invention;

FIGS. 12A to 12C are diagrams describing an example of equalization;

FIG. 13 is a flowchart describing an example of data recording;

FIG. 14 is a flowchart describing an example of data reading; and

FIG. 15 is a block diagram illustrating a configuration example of a personal computer.

### DETAILED DESCRIPTION OF THE PREFERRED EMBODIMENTS

A description will be given below of embodiments of the present invention with reference to the accompanying drawings.

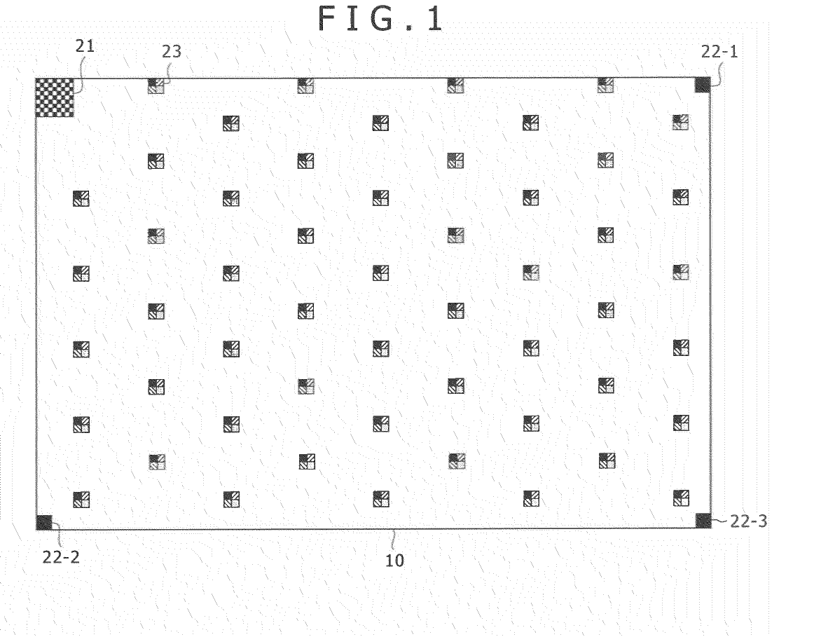

FIG. 1 is a diagram describing an example of a data recording scheme to which and embodiment of the present invention is applied.

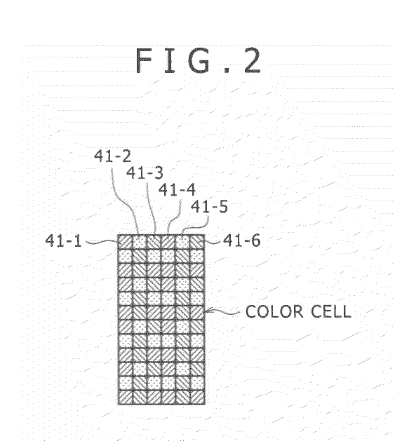

FIG. 1 illustrates an example in which data of a given length is recorded on a flat medium 10 such as a piece of paper by a recording scheme according to the embodiment. In this example, data is recorded as a graphic in a given color and form as it is printed on the surface of the medium 10, i.e., a piece of paper. It should be noted that a number of graphics called color cells, which will be described later with reference to FIG. 2, are printed on this piece of paper so that the recorded data can be read out by analyzing the colors of the color cells.

Control information 21 is printed at the top left edge of the medium 10 shown in FIG. 1. The control information 21 is made up, for example, of a set of white or black graphics. The control information 21 includes, for example, information which will be described later such as color cell size, number of colors used, pilot pattern, error correction scheme and interleaving scheme.

On the other hand, edge symbols 22-1 to 22-3 are printed respectively at the top right, bottom left and bottom right edges of the medium 10.

The edge symbols 22-1 to 22-3 are designed to allow for the data reader, which will be described later, to identify the size of the medium 10 so as to correct the position and angle of the medium 10, thus making it easy to read the recorded information. That is, when reading the data printed on the medium 10, the data reader can identify the four edges of the paper surface by detecting the control information 21 and edge symbols 22-1 to 22-3, thus making it possible for the data reader to identify the size of the paper surface. Further, by identifying the four edges of the paper surface, the data reader can correct the paper surface position, for example, by virtually rotating the paper surface if the paper surface is skewed, upside down or left side right.

The edge symbols 22-1 to 22-3 are in a preset color and form that can be readily recognized by the data reader. In this example, the same symbols 22-1 to 22-3 are printed as black rectangles.

Further, pilots 23, each made up of a graphic in a preset color, are printed on the medium 10. It should be noted that although many pilots are printed on the medium 10, the reference numeral is assigned only to the pilot 23 printed at the topmost and leftmost position.

Pilots are designed to allow for a data reader to equalize the colors of the color cells printed on paper, for example, if the printing on paper fades.

In this example, each pilot is printed as a rectangle made up of a combination of four rectangles, i.e., black, red, green and blue rectangles. Black serves as a reference color for dark areas, and red, green and blue are three primary colors of light. That is, pilots are configured in such a manner that even if a color cell in any color fades, it is possible to equalize the color cell color.

However, pilots need only serve as color references. Therefore, a pilot may be, for example, made up of CMYK (cyan, magenta, yellow and black) used for printing or YCbCr (one luminance signal and two color difference signals) used for broadcasting.

Pilots are printed at predetermined positions. For example, pilots are printed at a given vertical distance from the top edge of the medium 10 horizontally along a row and regularly at preset intervals. Pilots are further printed at a given vertical distance horizontally along a row and regularly at preset intervals. That is, pilots are arranged in such a manner that no matter in which area of the paper surface the printing fades, it is possible to equalize the color cell color.

It should be noted that the arrangement and configuration of pilots may be, for example, selected as appropriate so that information on the selection result is included in the control information 21.

On the surface of the medium 10, color cells are printed where none of the control information 21, edge symbols 22-1 to 22-3 and pilots is printed.

FIG. 2 is a diagram illustrating a configuration example of color cells. As illustrated in FIG. 2, each color cell is configured as an extremely small rectangle of a given color. In this example, six color cells 41-1 to 41-6 are printed horizontally along the first row in FIG. 2. Further, six color cells are printed horizontally along each of the second to twelfth rows. Each of these color cells serves as data to be recorded to the medium 10. That is, the recorded data can be read by reading the color of each of the color cells.

Each of the color cells is printed, for example, not only in a predetermined size and form but also in a color associated with the data to be recorded. The color of each color cell is one of a plurality of predetermined colors.

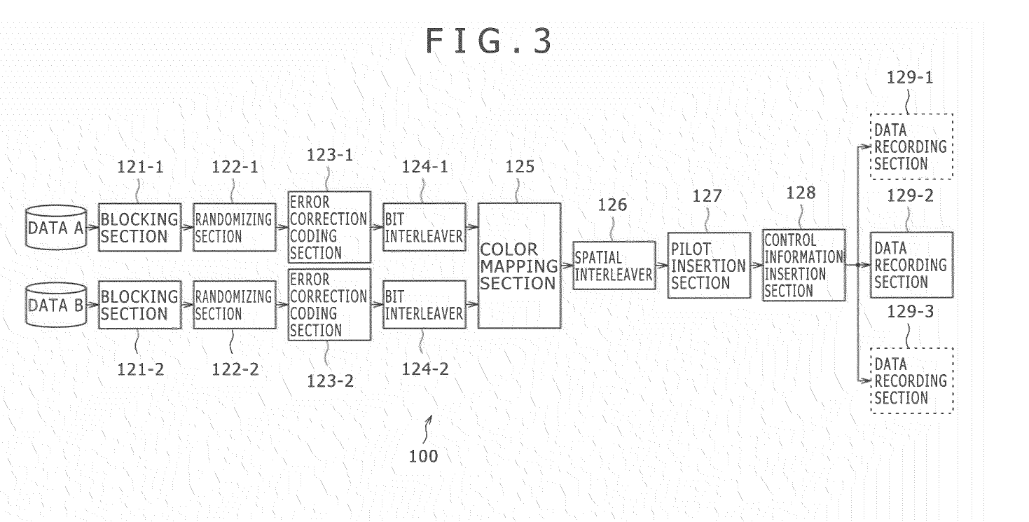

FIG. 3 is a block diagram illustrating a configuration example of a data recorder according to the embodiment of the present invention. FIG. 3 illustrates a configuration example of a data recorder 100 adapted to multiplex and record two pieces of data or data A and B.

A blocking section 121-1 divides the data A into blocks of a predetermined length. A blocking section 121-2 divides the data B into blocks of the predetermined length. The block size is determined, for example, in association with the number of pieces of data to be multiplexed and the surface size of the medium 10.

The sizes of the data A and B are not fixed in advance. Therefore, the blocking sections 121-1 and 121-2 divide the data A and B into the above blocks, respectively. It should be noted that each of the data A and B may be divided into a single or a plurality of blocks.

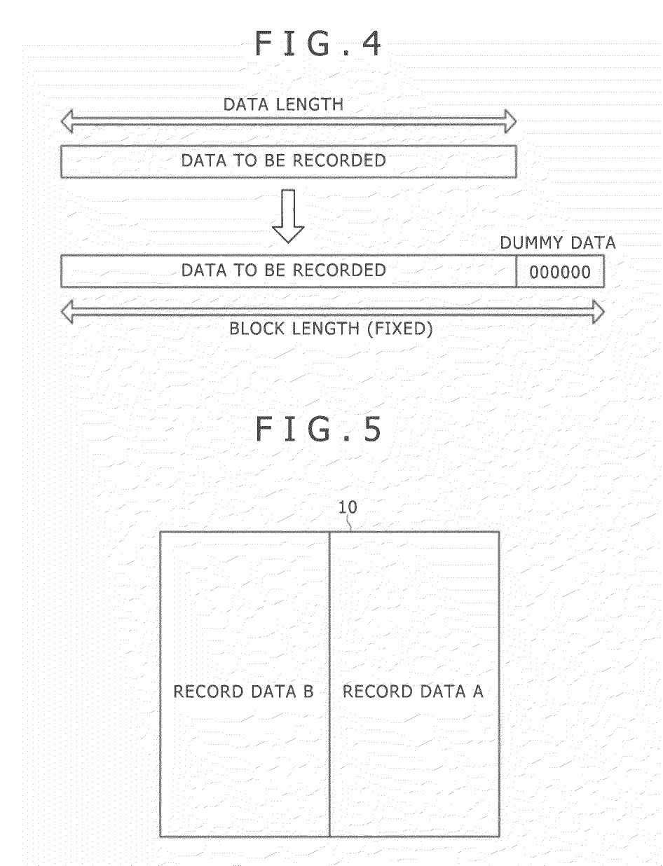

If the block length (block size) is greater than the length of the data to be recorded, the blocking sections 121-1 and 121-2 add dummy data (e.g., series of bits containing 0's) as illustrated in FIG. 4.

The two pieces of data processed by the blocking sections 121-1 and 121-2 are supplied respectively to randomizing sections 122-1 and 122-2 for randomizing (or energy dispersion).

Randomizing performed by the randomizing sections 122-1 and 122-2 is composed, for example, of multiplication by a 15th order PRBS (Pseudorandom Binary Sequence) adopted in European Terrestrial Digital Broadcasting (DVB-T).

The two pieces of data processed by and output from the randomizing sections 122-1 and 122-2 are supplied respectively to error correction coding sections 123-1 and 123-2. Each of the error correction coding sections 123-1 and 123-2 performs error correction coding on the input data. The error correction coding performed here is composed, for example, of a combination of LDPC (Low Density Parity Check) coding and BCH coding. Naturally, Reed-Solomon coding, convolutional coding or other coding scheme may be alternatively used. Still alternatively, the error correction coding sections 123-1 and 123-2 may perform error correction coding using different error correction coding schemes.

The two pieces of data processed by and output from the error correction coding sections 123-1 and 123-2 are supplied respectively to bit interleavers 124-1 and 124-2. The bit interleavers 124-1 and 124-2 are respectively functional blocks adapted to interleave the data. Each of the bit interleavers 124-1 and 124-2 performs, for example, parity interleaving adapted to interleave a parity bit of an LDPC code to a different parity bit position. Further, each of the bit interleavers 124-1 and 124-2 performs column twist interleaving or other process on the parity-interleaved LDPC code.

The two pieces of data processed by and output from the bit interleavers 124-1 and 124-2 are supplied to a color mapping section 125.

The color mapping section 125 multiplexes the two pieces of data output from the bit interleavers 124-1 and 124-2. Then, the same section 125 maps the multiplexed data to colors and color densities.

The data is mapped to colors, for example, in the following manner.

First, a color vector representation scheme such as RGB or YCbCr is determined. A description will be given here of an example in which RGB is used as a color vector representation scheme.

Two to the nth power different levels of density/luminance are defined for each of the base vectors, i.e., R, G and B. This makes it possible to represent 2^{N}×2^{N}×2^{N} colors by combining R, G and B, thus allowing for 3×N bits of information to be represented.

That is, the color mapping section 125 codes digital data in association with colors and color densities.

Density/luminance gray levels are determined, for example, in accordance with the type of data to be recorded or the type of data recorder or reader. For example, if the data recorder has high writing accuracy, or if the data reader has high reading accuracy, N may be increased so as to record more information. On the other hand, if the data is highly important, N may be reduced so as to make the data easy to read. Further, if there is a large amount of data, N may be increased so as to increase the storage capacity.

Data is multiplexed, for example, in the following manner. A description will be given below with reference to FIGS. 5 to 8.

FIG. 5 is a diagram describing an example of spatial multiplexing. FIG. 5 illustrates an example in which the data A and B is spatially multiplexed as a result of printing of the data A on the right side of the surface of the medium 10 and the data B on the left side thereof.

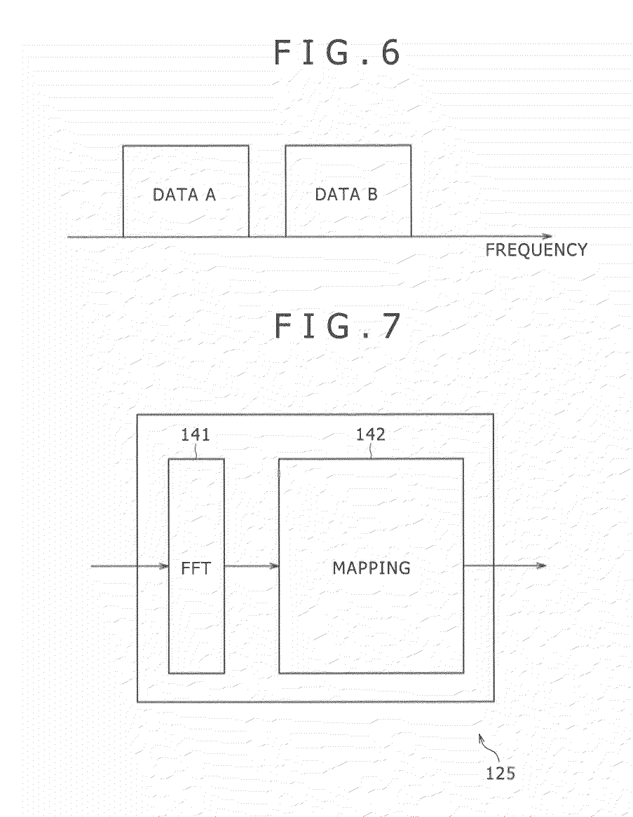

FIG. 6 is a diagram describing an example of frequency multiplexing. FIG. 6 illustrates an example in which the data A and B is frequency-multiplexed as a result of recording of the data A in a low frequency band and the data B in a high frequency band.

In order to record data through frequency multiplexing, the data A is recorded, for example, as data in a low frequency band by arranging color cells at large intervals on the paper surface. On the other hand, the data B is recorded as data in a high frequency band by arranging color cells without any intervals. That is, the multiplexed data A and B is recorded in such a manner that the two pieces of data can be distinguished from each other by the frequencies associated with changes in color cell color in the two-dimensional space of the paper surface on which the image is printed.

FIG. 7 is a block diagram illustrating a detailed configuration example of the color mapping section 125 adapted to frequency-multiplex data. In this example, the pieces of data output from the bit interleavers 124-1 and 124-2 are supplied to an FFT calculation block 141. Then, the data resulting from the FFT calculation performed by the FFT calculation block 141 is supplied to a mapping block 142 for color mapping.

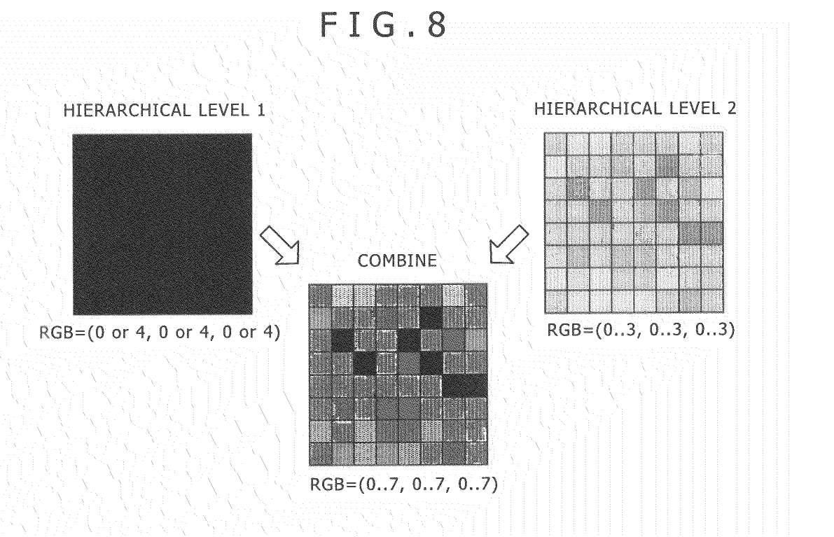

FIG. 8 is a diagram describing an example of hierarchical multiplexing. The term “hierarchical multiplexing” here refers to a scheme adapted to multiplex a plurality of pieces of information to the same color cell. A description will be given here of an example in which information is multiplexed to two hierarchical levels (hierarchical levels 1 and 2) using 64(=8×8) color cells.

In FIG. 8, the R, G and B levels (intensities) of all the 64 color cells in hierarchical level 1 are set to 0 or 4. That is, there are eight possible combinations in hierarchical level 1 made up of 64 color cells, namely, (R, G, B)=(0, 0, 0), (0, 0, 4), (0, 4, 0), (0, 4, 4), (4, 0, 0), and so on up to (4, 4, 4). This makes it possible to represent three bits of data (2³=8) using the 64 color cells in hierarchical level 1.

In hierarchical level 2, on the other hand, each of the R, G and B levels (intensities) of all the 64 color cells is set to any one of 0 to 3. That is, there are 64 possible combinations for the color cells in hierarchical level 2, namely, (0, 0, 0), (0, 0, 1), (0, 0, 2), (0, 0, 3), (0, 1, 0), and so on up to (3, 3, 3). Therefore, the number of pieces of information that can be represented by the 64 color cells is 4096 (=64×64) possible pieces of information. This makes it possible to represent 12 bits of data (2¹²=4096) using the 64 color cells in hierarchical level 2.

That is, hierarchical multiplexing allows for 15 bits of data to be recorded using 64 color cells by combining hierarchical levels 1 and 2. When hierarchical levels 1 and 2 are combined, the level of each of R, G and B of the 64 color cells is set to any one of 0 to 7.

In this case, the data reader can separate the multiplexed data, for example, in the following manner.

For example, if the R, G and B levels of the color cells are 4 or higher when the color cells are read by the data reader, the R, G and B levels in hierarchical level 1 can be determined to be 4. Further, the R, G and B levels in hierarchical level 2 can be determined by subtracting 4 from each of the R, G and B levels that are 4 or higher.

On the other hand, if the R, G and B levels of the color cells are lower than 4, the R, G and B levels in hierarchical level 1 can be determined to be 0. Further, the R, G and B levels lower than 4 can be determined as-is as the R, G and B levels in hierarchical level 2.

Further, hierarchical multiplexing as shown in FIG. 8, for example, makes it possible even for a data reader with low reading accuracy to read the data at least in hierarchical level 1 if not in both hierarchical levels. For example, an image is printed so that the data in hierarchical level 1 can be read by a simple and compact data reader. A high-performance data reader is used if the data in hierarchical level 2 must be read.

In addition to the above, block multiplexing may be used. In block multiplexing, each block is made up of the preset number of color cells. The blocks to which the data A is recorded and those to which the data B is recorded are arranged in succession on the paper surface. Alternatively, block multiplexing may be performed, for example, so that the control information 21 contains information specifying where the blocks to which the data A is recorded and those to which the data B is recorded are arranged.

Still alternatively, vector multiplexing may be used that is designed to record data for each color base vector. For example, if R, G and B are used as color vectors, the data A may be recorded with red, the data B may be recorded with green, and data C may be recorded with blue.

Referring back to FIG. 3, the data processed by and output from the color mapping section 125 is supplied to a spatial interleaver 126. The same interleaver 126 sorts (spatially interleaves) the data mapped to the color cells so as to spatially distribute the data arrangement (e.g., arrangement in the two-dimensional space associated with the surface of the medium 10).

For example, if data is recorded by printing color cells, the data in a specific part of the printed paper surface may be lost in a concentrated manner due, for example, to stains, smudges, scratches or tears. In the event of such a concentrated loss, data is often impossible to recover, for example, even with error correction coding.

In order to prevent such an unrecoverable loss, it is effective to sort the data in advance prior to printing and restore the sorted data back to the original form and error-correction-decode the restored data at the time of reading.

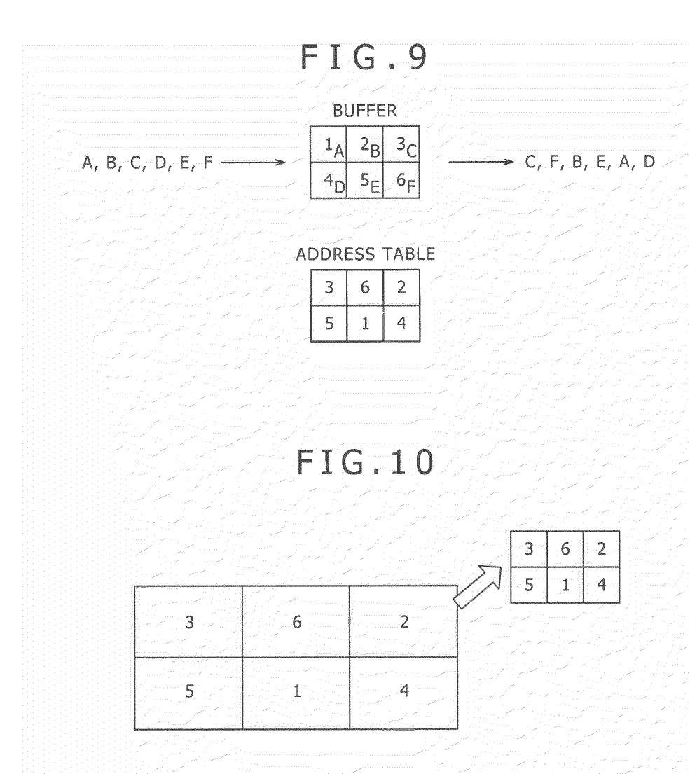

The spatial interleaver 126 sorts data, for example, through random interleaving, a scheme that offers high spatial distribution efficiency. FIG. 9 is a diagram describing random interleaving.

A buffer shown in FIG. 9 has six (=2×3) addresses and is fed with a data sequence shown at left in FIG. 9. In this example, a data sequence “A, B, C, D, E, F” is shown. The addresses in the storage areas of the buffer are numbered “1, 2, 3, 4, 5, 6” sequentially from top left. The data sequence “A, B, C, D, E, F” is stored in the storage areas at the respective addresses in ascending order.

That is, the data “A” is stored in the storage area at address 1 of the buffer, the data “B” is stored in the storage area at address 2 thereof, and so on, and data “F” is stored in the storage area at address 6 thereof.

FIG. 9 also shows an address table. If data is written to all the storage areas of the buffer, the data is read out from the buffer based on this address table. In this example, the address table contains the addresses “3, 6, 2” from top left and “5, 1, 4” from bottom left. It should be noted that the same address table as that shown in FIG. 9 is used in the data reader which will be described later.

The data written to the buffer is read out therefrom in the order specified based on the address table. In this case, the data is read out in the order of the addresses “3, 6, 2, 5, 1, 4” of the buffer, and a data sequence shown on the right of the buffer in FIG. 9 is output. In this example, the input data sequence “A, B, C, D, E, F” is sorted into a data sequence “C, F, B, E, A, D” and output.

It should be noted that a buffer with a larger number of addresses is practically used in combination with a highly random address table to sort data through random interleaving which offers high spatial distribution efficiency.

In such data sorting through random interleaving, it is ideal to have ready as many buffer addresses as there are color cells that can be printed on the paper surface on which data is to be recorded. However, this leads to an enormous size of the address table in the case of a large paper surface, resulting in more time required to record and read data and possibly reduced convenience of the data recorder and reader.

If the paper surface is large, for example, an address table based on recurrent random interleaving may be used.

FIG. 10 is a diagram illustrating an address table based on recurrent random interleaving. The address table shown in FIG. 10 is hierarchically configured. In this example, six addresses are provided in the address table shown in FIG. 10 as in the address table shown in FIG. 9. These addresses are numbered “3, 6, 2, 5, 1, 4” sequentially from top left. In the case of the address table shown in FIG. 10, however, each address cell is an address of a block associated with six addresses. For example, data recorded to the block at address 2 in the first hierarchical level is further sorted based on the address table whose addresses are numbered “3, 6, 2, 5, 1, 4” sequentially from top left.

For example, the paper surface is divided into six blocks. Addresses 1, 2 and 3 are assigned sequentially to the blocks from top left, and addresses 4, 5 and 6 are assigned to the blocks from bottom left. Then, these addresses are brought into association with the address table in the first hierarchical level. Similarly, the data to be recorded is divided into six blocks. Then, the data in the first block is sorted so that it is recorded at the bottom center of the paper surface based on the address table in the first hierarchical level. On the other hand, the data in the second block is sorted so that it is recorded at the top right of the paper surface. Similarly, the data in the third to sixth blocks is sorted based on the address table in the first hierarchical level.

Then, in order to record the data to each of the blocks, the data is further sorted based on the address table in the second hierarchical level. We assume, for example, that the data sequence of the data in the second block is “A, B, C, D, E, F.” When recorded to the top right of the paper surface, this data sequence is sorted into a data sequence “C, F, B, E, A, D” based on the address table in the second hierarchical level.

As described above, an address table based on recurrent random interleaving may be used to sort data.

It should be noted that although, in this example, a description has been given of an example in which an address table based on recurrent random interleaving is made up of two hierarchical levels, an address table may be made up of a greater number of hierarchical levels.

It should be noted that the data sorting scheme used by the spatial interleaver 126 is not limited to the above. However, using an excessively complicated interleaving scheme leads to a larger circuit scale, resulting in higher cost and larger size of the data reader. For example, several interleaving schemes may be selectable, with information identifying the selected interleaving scheme contained in the control information 21.

Referring back to FIG. 3, the data processed by and output from the spatial interleaver 126 is supplied to a pilot insertion section 127. The pilot insertion section 127 inserts data, associated with pilots which were described with reference to FIG. 1, into the data processed by and output from the spatial interleaver 126.

As described above, pilots, each made up of a graphic in a predetermined color, form and size, are printed at predetermined intervals. The colors, graphics, printing positions and other information of the pilots are set in the pilot insertion section 127.

For example, printing pilots at a high density permits correction of color unevenness with high accuracy on one hand. On the other hand, this leads to a reduced amount of data that can be recorded, with the reduction being equivalent to the number of pilots printed. For example, the patterns such as pilot colors, graphics, printing positions and other information may be selectable.

It should be noted that, in the example described with reference to FIG. 1, the pilots are each made up of a combination of four rectangles, i.e., black, red, green and blue rectangles. That is, the pilots shown in FIG. 1 are represented as fixed symbols serving as a color reference that allow for the data reader to equalize the colors of the color cells printed on the paper surface, for example, if the printing on the paper surface fades. However, data may be superimposed on the pilots to such an extent as not to degrade the color correction performance.

For example, each pilot is made up of four colors of black, red, green and blue in the example shown in FIG. 1. However, one of these four colors, for example, may be recorded. This makes it possible to further represent another piece of information, i.e., information expressed by which of black, red, green and blue a pilot printed at a predetermined position is. That is, data is superimposed on the pilot.

The superimposition of data on a pilot as described above leads to degraded correction performance, for example, in areas where the pilots of the same color are printed in a concentrated manner. However, if sufficiently dense and sufficiently random data is superimposed on a pilot, it can be said that degradation in correction performance does not pose any problem.

Alternatively, each of black, red, green and blue may be recorded in multi-levels. For example, when each of R, G and B is represented by eight bits, two types of pilots or R, G, B=(256, 0, 0) and (128, 0, 0), are used for red. This makes it possible to represent another piece of information, i.e., information expressed by which of the two types of RGB levels a pilot printed at a predetermined position has. As a result, data is superimposed on a pilot, as well.

As described above, when data is superimposed on a pilot, providing a number of different RGB levels (increasing the degree of multi-levelness) leads to degraded correction performance. However, if the degree of multi-levelness is set to such an extent that the types of RGB levels are not erroneously recognized, it can be said that degradation in correction performance does not pose any problem.

The data processed by and output from the pilot insertion section 127 is supplied to a control information insertion section 128. As described with reference to FIG. 1, control information is, for example, printed at top left and made up of a set of white or black graphics.

The data reader requires control information before reading the data on the paper surface. That is, control information must be read by the data reader first before anything else. Therefore, this information is made up of a set of white or black graphics so as to reduce the likelihood that the information may be erroneously recognized due, for example, to fading of the paper surface.

Control information contains, for example, the size of the above color cells and the number of colors used for the color cells. Further, control information contains not only the patterns such as pilot colors, graphics and printing positions adopted (selected) by the pilot insertion section 127 but also the superposition scheme used if data is superimposed on pilots. Still further, control information contains information such as error correction coding scheme adopted (selected) by the error correction coding sections 123-1 and 123-2 and interleaving scheme adopted (selected) by the spatial interleaver 126. As described above, information identifying the patterns and schemes selected by the functional blocks of the data recorder 100 is supplied in advance to the control information insertion section 128.

Then, the control information insertion section 128 combines these pieces of information as control information and inserts data of this control information into the data output from the pilot insertion section 127. It should be noted that control information is also subjected to a predetermined type of error correction coding, mapped to white or black and spatially interleaved (sorted) for recording purposes. It should be noted that control information need not always be mapped to white or black. Instead, control information may be mapped to other colors so long as the colors are easy to read.

It should be noted that data required to print the edge symbols 22-1 to 22-3 described above with reference to FIG. 1 is also inserted by the control information insertion section 128.

The data processed by and output from the control information insertion section 128 is supplied to data recording sections 129-1 to 129-3. The data recording sections 129-1 to 129-3 print an image on paper or other medium based on the data supplied. This allows, for example, for data to be recorded on the medium 10 using color cells as described above with reference to FIG. 1.

In the example shown in FIG. 3, three data recording sections or the data recording sections 129-1 to 129-3 are provided in the data recorder 100. If data is printed simultaneously on three media with three data recording sections, for example, the data will highly likely be restored properly by loading the three media simultaneously into the data reader even in the event of failure to record the data properly, due to ink quantity, paper condition or other cause.

Naturally, one data recording section may be provided in the data recorder 100.

Data is recorded by the data recorder 100 as described above.

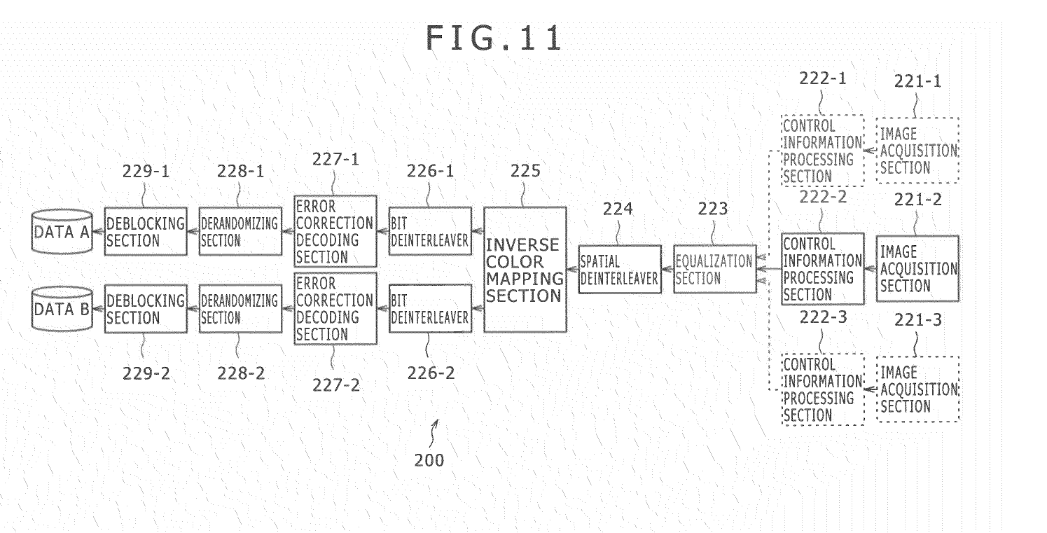

A description will be given next of a data reader adapted to read data recorded by the data recorder 100. FIG. 11 is a block diagram illustrating a configuration example of a data reader according to the embodiment of the present invention.

A data reader 200 shown in FIG. 11 reads data printed and recorded on the medium 10, for example, as shown in FIG. 1. A description will be given here of an example in which multiplexed data, obtained by multiplexing the data A and B, is read.

Image acquisition sections 221-1 to 221-3 acquire, for example, an image on the paper surface of the medium 10.

The image acquisition sections 221-1 to 221-3 each include, for example, a scanner, digital camera, video camcorder or other device and output the acquired image as digital data. Digital data output from the same sections 221-1 to 221-3 represents, for example, the colors associated with all the coordinate positions of the paper surface.

It should be noted that the image acquisition sections 221-1 to 221-3 may perform image processing such as noise removal or color correction.

The pieces of data output from the image acquisition sections 221-1 to 221-3 are supplied respectively to control information processing sections 222-1 to 222-3.

The control information processing sections 222-1 to 222-3 read out control information based on the pieces of data output from the image acquisition sections 221-1 to 221-3. That is, the same sections 222-1 to 222-3 identify the data mapped to the white or black graphics of the control information 21 shown in FIG. 1 and reproduce the control information through deinterleaving, error correction and other processes.

As a result, the above color cell size and the number of colors used for the color cells are identified. Further, more information is identified including not only the patterns such as pilot colors, graphics and printing positions adopted (selected) by the pilot insertion section 127 but also the superposition scheme used if data is superimposed on pilots. Still further, the error correction scheme adopted (selected) by the error correction coding sections 123-1 and 123-2, the interleaving scheme adopted (selected) by the spatial interleaver 126 and other information are identified.

These pieces of information obtained by reproducing control information are supplied first to an equalization section 223, spatial deinterleaver 224, inverse color mapping section 225 and error correction decoding sections 227-1 and 227-2.

Further, the control information processing sections 222-1 to 222-3 identify the coordinate positions of the edge symbols 22-1 to 22-3 printed at the edges of the paper surface, thus identifying the paper surface size and correcting the coordinate positions. As described above, the edge symbols 22-1 to 22-3 are designed to allow for the data reader 200 to identify the size of the medium 10 so as to correct the position and angle of the medium 10, thus making it easy to read the recorded information.

That is, the coordinate positions of the four edges of the paper surface are identified as the data reader 200 detects the control information 21 and edge symbols 22-1 to 22-3, thus allowing for the paper surface size to be identified. Further, as a result of identification of the four edges, the coordinate positions of the color cells are corrected, for example, by virtually rotating the paper surface if the paper surface is skewed, upside down or left side right.

The pieces of data processed by and output from the control information processing sections 222-1 to 222-3 are supplied to the equalization section 223.

It should be noted that, in the example shown in FIG. 11, the three image acquisition sections 221-1 to 221-3 and three control information processing sections 222-1 to 222-3 are provided in the data reader 200. This configuration is intended for a case in which three data recording sections are provided in the data recorder 100. The reason for this is that, even in the event of failure to record data properly, due to ink quantity, paper condition or other cause, the data will highly likely be restored properly by loading the three media simultaneously into the data reader.

For example, if one data recording section is provided in the data recorder 100, it is only necessary to provide one image acquisition section and one control information processing section in the data reader 200.

If data is supplied from three control information processing sections, the equalization section 223 performs equalization by combining the three pieces of data, for example, through averaging. Alternatively, the same section 223 may perform equalization after calculating a predetermined reliability evaluation value for each of the three pieces of data and selecting the piece of data with the highest evaluation value.

The equalization section 223 corrects the colors of the color cells using pilots.

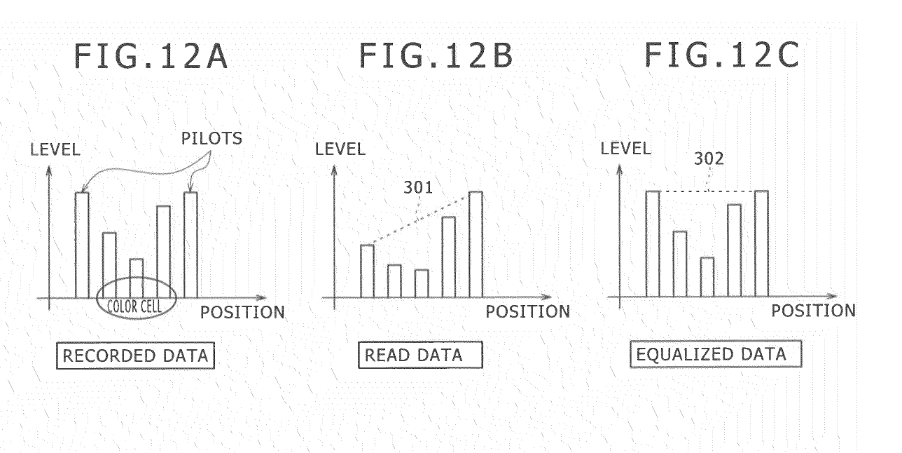

FIGS. 12A to 12C are diagrams describing an example of correction (equalization) of color cell colors performed by the equalization section 223. FIGS. 12A to 12C are graphs illustrating the levels of the pilots and color cells with the horizontal axis representing the coordinate position and the vertical axis representing the R, G or B level. Here, we assume that only the levels of the R component of the R, G and B components are shown for ease of description.

FIG. 12A is a graph illustrating the R component levels of pilots and color cells immediately after printing onto the paper surface. In FIG. 12A, the R component levels associated with coordinate positions are shown by a bar graph. In the graph, the leftmost and rightmost bars show the R component levels of two pilots. The bars at coordinate positions sandwiched between the two pilots show the R component levels of the color cells.

FIG. 12B is a graph illustrating the R component levels of the pilots and color cells when the pilots and color cells are read by the data reader 200. In FIG. 12B, the R component levels associated with the coordinate positions are shown by a bar graph. In the graph, the leftmost and rightmost bars show the R component levels of two pilots. The bars at coordinate positions sandwiched between the two pilots show the R component levels of the color cells.

In FIG. 12B, the R component level is attenuated as we go from right to left along the horizontal axis due, for example, to fading of the paper surface.

If this data is read without being subjected to equalization, it is impossible to properly reproduce the data recorded by the data recorder 100. The reason for this is that, as a result of the attenuation of the R, G and B levels of the color cells, the information represented by each of the color cells has changed from the one that was recorded.

In the data reader 200, however, the control information has already been reproduced by the control information processing sections 222-1 to 222-3. Therefore, the control information has been identified, including not only the patterns such as pilot colors, graphics and printing positions adopted (selected) by the pilot insertion section 127 but also the superposition scheme used if data is superimposed on pilots. As a result, the equalization section 223 can process the coordinate positions and RGB levels of the pilots as known values.

That is, the equalization section 223 can identify the leftmost and rightmost bars as showing the R component levels of the two pilots in the graph of FIG. 12B. Further, the equalization section 223 can identify the original R component levels of the pilots.

This makes it possible for the equalization section 223 to correct the colors of the color cells using the pilots as illustrated in FIG. 12C.

FIG. 12C is a graph illustrating the R component levels of the pilots and color cells after the equalization by the equalization section 223. In FIG. 12C, the R component levels associated with the coordinate positions are shown by a bar graph. In the graph, the leftmost and rightmost bars show the R component levels of two pilots. The bars at coordinate positions sandwiched between the two pilots show the R component levels of the color cells.

In FIG. 12C, the attenuation of the R component levels, seen in FIG. 12B as we go from the right to left coordinate positions along the horizontal axis, is corrected. That is, the equalization section 223 identifies the levels that should be shown by the leftmost and rightmost bars in the graph, thus identifying the gain for each coordinate position required to perform correction so as to change a line 301 shown in FIG. 12B into a line 302 shown in FIG. 12C. Then, the equalization section 223 multiplies the level of each bar by the gain for that bar in association with the coordinate position, thus correcting the colors of the color cells.

It should be noted that the above correction may be performed by simple linear interpolation. Alternatively, the correction may be performed with a multi-tap interpolation filter or two-dimensional filter using a plurality of pilots. This provides even higher accuracy in color correction.

Still alternatively, the colors of the color cells may be corrected through MRC (Maximum Ratio Combining). In this case, the plurality of color cells are combined based on the S/N ratio calculated for each color cell. It should be noted that the color cells may be simply combined, for example, through averaging.

The equalization is performed as described above.

On the other hand, when an image of data to be recorded is printed, for example, on paper, the image is often printed in different hues depending on the printer model. For example, different printer models may enhance red differently and produce different brightness and darkness levels, thus resulting in different hues.

For example, information related to the color correction in the equalization performed when data is read by the data reader 200 may be fed back to the data recorder 100 so that the colors mapped by the color mapping section 125 are changed as appropriate.

This provides improved quality in data recording and reading, for example, irrespective of the printer model used.

On the other hand, a description has been given here by assuming, as an example, a case in which an image is printed on white paper. However, it is also possible to print, for example, an image, based on the data recording scheme to which the present invention is applied, on top of another image using pilots.

For example, when the data recording sections 129-1 to 129-3 print an image associated with data to be recorded in the data recorder 100, the image is printed on a paper surface already printed with a photograph or other image. It should be noted that the image associated with the data to be recorded is printed with such a thinness as not to spoil the photograph or other image.

Then, when the recorded data is read by the data reader 200, the colors of the color cells are corrected using pilots. At the same time, the pixels of colors other than those of the color cells are removed as noise. That is, the photograph or other image is removed from the image obtained by the image acquisition sections 221-1 to 221-3.

By doing so, the densities of the colors of the color cells are restricted so as not to spoil the photograph or other image. This leads to a smaller amount of data that can be recorded than when data is printed on white paper. However, this makes it possible to record desired data, for example, on an arbitrary page of a magazine, possibly providing improved convenience.

Referring back to FIG. 11, the data processed by and output from the equalization section 223 is supplied to the spatial deinterleaver 224.

The spatial deinterleaver 224 restores the data, sorted by the spatial interleaver 126, back to its original state. The spatial deinterleaver 224 has the same address table as used by the spatial interleaver 126 and sorts, for example, the data sequence “C, F, B, E, A, D” into the data sequence “A, B, C, D, E, F.”

The data processed by and output from the spatial deinterleaver 224 is supplied to the inverse color mapping section 225.

The inverse color mapping section 225 converts the color data obtained from the color cells into digital data according to a predetermined scheme. Further, the same section 225 separates the multiplexed data into the data A and B. That is, the process performed by the inverse color mapping section 225 is a calculation conducted in reverse order to the process performed by the color mapping section 125.

The data associated with the data A separated by the process performed by the inverse color mapping section 225 is supplied to a bit deinterleaver 226-1, and the data associated with the data B is supplied to a bit deinterleaver 226-2.

The bit deinterleavers 226-1 and 226-2 respectively perform calculations in reverse order to the processes performed by the bit interleavers 124-1 and 124-2.

The two pieces of data respectively processed by and output from the bit deinterleavers 226-1 and 226-2 are supplied respectively to the error correction decoding sections 227-1 and 227-2.

The error correction decoding sections 227-1 and 227-2 perform decoding appropriate respectively to the error correction coding performed by the error correction coding sections 123-1 and 123-2.

The two pieces of data respectively processed by and output from the error correction decoding sections 227-1 and 227-2 are supplied respectively to derandomizing sections 228-1 and 228-2 for derandomizing (or inverse energy dispersion).

The process performed by the derandomizing sections 228-1 and 228-2 is a calculation conducted in reverse order to the process performed by the randomizing sections 122-1 and 122-2.

The two pieces of data respectively processed by and output from the derandomizing sections 228-1 and 228-2 are supplied respectively to deblocking sections 229-1 and 229-2.

The deblocking sections 229-1 and 229-2 respectively perform calculations in reverse order to the processes performed by the blocking sections 121-1 and 121-2, thus constructing and outputting the data A and B.

Data printed and recorded on the surface of the medium 10 by the data recorder 100 is read and reproduced by the data reader 200 as described above.

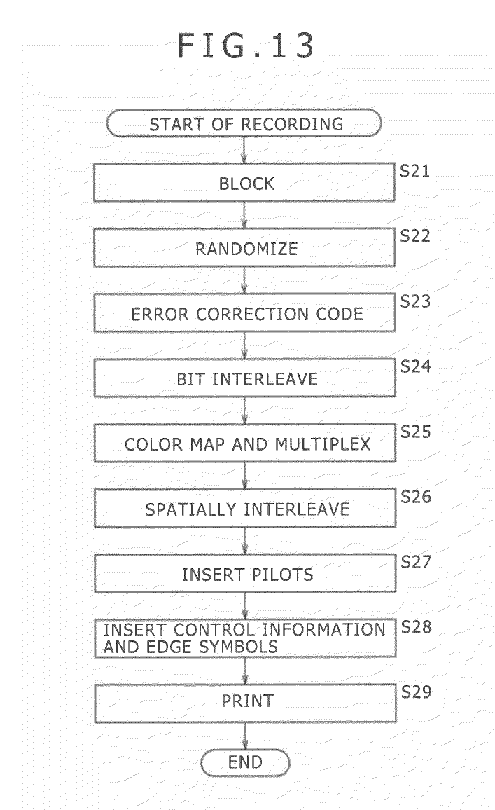

A description will be given next of an example of data recording performed by the data recorder 100 according to the embodiment of the present invention with reference to the flowchart shown in FIG. 13.

In step S21, data is blocked. That is, the blocking section 121-1 divides the data A into blocks of a predetermined length, and the blocking section 121-2 divides the data B into blocks of the predetermined length.

At this time, the data is divided into blocks whose size is determined according to the number of pieces of data to be multiplexed and the surface size of the medium 10. Dummy data is added as necessary as illustrated, for example, in FIG. 4.

In step S22, the randomizing sections 122-1 and 122-2 perform randomizing (or energy dispersion).

At this time, the randomizing performed by the randomizing sections 122-1 and 122-2 is composed, for example, of multiplication by a 15th order PRBS (Pseudorandom Binary Sequence) adopted in European Terrestrial Digital Broadcasting (DVB-T).

In step S23, each of the error correction coding sections 123-1 and 123-2 performs error correction coding on the input data. The error correction coding performed here is composed, for example, of a combination of LDPC (Low Density Parity Check) coding and BCH coding. Naturally, Reed-Solomon coding, convolutional coding or other coding scheme may be alternatively used. Still alternatively, the error correction coding sections 123-1 and 123-2 may perform error correction coding using different error correction coding schemes.

In step S24, each of the bit interleavers 124-1 and 124-2 performs bit interleaving.

At this time, for example, parity interleaving is performed in which a parity bit of an LDPC code is interleaved to a different parity bit position. Further, column twist interleaving or other process is performed on the parity-interleaved LDPC code.

In step S25, the color mapping section 125 multiplexes the data output from the bit interleavers 124-1 and data output from the bit interleavers 124-2. Then, the same section 125 maps the multiplexed data to colors.

At this time, the mapping to colors is conducted, for example, by first determining a color vector representation scheme such as RGB or YCbCr and then defining two to the nth power different levels of density/luminance for each of the base vectors. On the other hand, data multiplication is achieved through spatial interleaving as shown in FIG. 5, frequency interleaving as shown in FIG. 6 or hierarchical interleaving as shown in FIG. 8. Alternatively, block multiplexing or vector multiplexing may be used.

In step S26, spatial interleaving is performed.

At this time, as described earlier, the spatial interleaver 126 sorts the data, for example, through random interleaving as shown in FIG. 9. Alternatively, the data is sorted using an address table based on recurrent random interleaving as shown in FIG. 10.

In step S27, the pilot insertion section 127 inserts data, associated with pilots which were described with reference to FIG. 1, into the data processed by and output from the spatial interleaver 126. It should be noted that data may be superimposed on pilots as described earlier.

In step S28, the control information insertion section 128 inserts control information and edge symbols.

At this time, control information may contain, for example, the color cell size and the number of colors used for the color cells, as described earlier. Further, control information may contain information including not only the patterns such as pilot colors, graphics and printing positions adopted (selected) by the pilot insertion section 127 in step S27 but also the superposition scheme used if data is superimposed on pilots. Still further, control information may contain information including the error correction coding scheme adopted (selected) by the error correction coding sections 123-1 and 123-2 in step S23 and the interleaving scheme adopted (selected) by the spatial interleaver 126.

Then, the control information insertion section 128 combines these pieces of information as control information and inserts data of this control information into the data output from the pilot insertion section 127 following the process in step S27. It should be noted that control information is also subjected to a predetermined error correction coding, mapped to white or black and spatially interleaved (sorted).

In step S28, on the other hand, data required to print the edge symbols 22-1 to 22-3 described above with reference to FIG. 1 is also inserted by the control information insertion section 128.

In step S29, the data recording sections 129-1 to 129-3 print an image on paper or other medium based on the data output as a result of the process in step S28.

Data is recorded as described above.

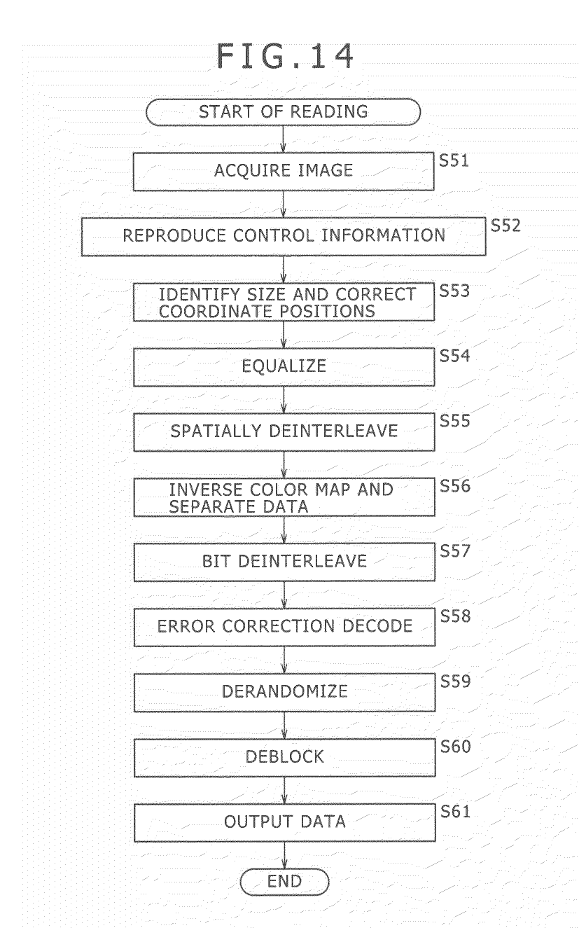

A description will be given next of an example of data reading performed by the data reader 200 according to the embodiment of the present invention with reference to the flowchart shown in FIG. 14.

In step S51, the image acquisition sections 221-1 to 221-3 acquire, for example, an image on the paper surface of a medium. At this time, image processing may be performed, for example, to remove noise or correct the colors. Here, data is output which represents, for example, the colors associated with all the coordinate positions of the paper surface based on the acquired image.

In step S52, the control information processing sections 222-1 to 222-3 reproduce control information. At this time, control information is read out based on the data output as a result of the process performed in step S51. The control information is reproduced, for example, by identifying the data mapped to the white or black graphics of the control information 21 shown in FIG. 1 and performing deinterleaving, error correction and other processes.

This identifies, for example, the color cell size and the number of colors used for the color cells. This also identifies the patterns such as pilot colors, graphics and printing positions, the superposition scheme used if data is superimposed on pilots, the error correction and interleaving schemes and other information.

In step S53, the control information processing sections 222-1 to 222-3 identify the size of the medium and correct the coordinate positions.

At this time, the control information processing sections 222-1 to 222-3 identify the coordinate positions of the edge symbols printed at the edges of the paper surface, thus identifying the paper surface size and correcting the coordinate positions.

In step S54, the equalization section 223 performs equalization.

That is, the colors of the color cells are corrected using pilots as described earlier with reference to FIG. 12. It should be noted that the information identified as a result of the process performed in step S52 is referred to in the equalization. This information includes, for example, the patterns such as pilot colors, graphics and printing positions.

On the other hand, if data is supplied from three control information processing sections (control information processing sections 222-1 to 222-3), the equalization section 223 performs equalization by combining the three pieces of data, for example, through averaging.

In step S55, the spatial deinterleaver 224 performs spatial deinterleaving.

That is, in step S55, the spatial deinterleaver 224 restores the data, sorted by the spatial interleaver 126 in the process performed in step S26 shown in FIG. 13, back to its original state.

In step S56, the inverse color mapping section 225 performs inverse color mapping and separates the multiplexed data.

That is, the inverse color mapping section 225 converts the color data obtained from the color cells into digital data according to a predetermined scheme. Further, the same section 225 separates the multiplexed data into the data A and B.

It should be noted that the process performed by the inverse color mapping section 225 in step S56 is a calculation conducted in reverse order to the process performed by the color mapping section 125 in step S25 shown in FIG. 13.

In step S57, the bit deinterleavers 226-1 and 226-2 perform bit deinterleaving.

That is, in step S57, the bit deinterleavers 226-1 and 226-2 perform a calculation in reverse order to the process performed by the bit interleavers 124-1 and 124-2 in step S24 shown in FIG. 13.

In step S58, the error correction decoding sections 227-1 and 227-2 perform decoding appropriate to the error correction coding performed by the error correction coding sections 123-1 and 123-2 in step S23 shown in FIG. 13. It should be noted that the error correction scheme identified as a result of the process performed in step S52 is referred to in the decoding.

In step S59, the derandomizing sections 228-1 and 228-2 perform derandomizing.

That is, the process performed by the derandomizing sections 228-1 and 228-2 in step S59 is a calculation conducted in reverse order to the process performed by the randomizing sections 122-1 and 122-2 in step S22 shown in FIG. 13.

In step S60, the deblocking sections 229-1 and 229-2 perform deblocking.

That is, in step S60, the deblocking sections 229-1 and 229-2 perform a calculation in reverse order to the process performed by the blocking sections 121-1 and 121-2 in step S21.

In step S61, the deblocking sections 229-1 and 229-2 output the data (e.g., data A and B) obtained as a result of the process performed in step S60.

Data reading is performed as described above.

In the case of color printing, for example, a printed matter may fade over time. That is, fading to an extent not problematic for black and white binary recording may result in non-reproducible data for color cells.

In order to readily record and read a large amount of data by using color cells, data must be reproduced properly even in the presence of such fading. On the other hand, if data to be recorded is printed, for example, on paper, the paper surface is prone to local smudges and scratches despite efforts to preserve the surface carefully. Data damaged by such smudges and scratches is difficult to recover retrospectively. Existing techniques have failed to resolve these problems.

In the present invention, the data recording is performed as described above with reference to FIG. 13, and the data reading is performed as described above with reference to FIG. 14, thus resolving the above problems.

For example, the data recording performed by the data recorder 100 by inserting pilots and the color correction performed by the data reader 200 using pilots allow for proper data reproduction even in the presence of fading.

Further, the spatial interleaving performed by the data recorder 100 and the spatial deinterleaving performed by the data reader 200 make it highly likely that data will be retrospectively recovered even in the presence of damage due to smudges and scratches.

Still further, bit interleaving and error correction coding can provide even higher reliability of read data.

Still further, performing different types of multiplexing allows for recording of a plurality of pieces of data on a single medium using color cells, thus achieving a highly efficient recording/reproduction system.

A description has been given above of an example in which data is recorded as a result of printing on paper or other medium by the data recorder 100. However, the medium may be a display so that the data reader 200 reads an image appearing on the display.

That is, the data recording according to the present invention is not limited to that achieved by printing, and may be that achieved by displaying an image.

On the other hand, a description has been given above assuming that the image of data recorded by the data recording scheme according to the present invention is primarily an image displayed as a still image. However, the image may be, for example, that displayed as one frame of a moving image.

Alternatively, the data recorder 100 may output an image, associated with data to be recorded, as image data coded according to JPEG or other coding scheme so that the data reader 200 reads the recorded data by reproducing the image data.

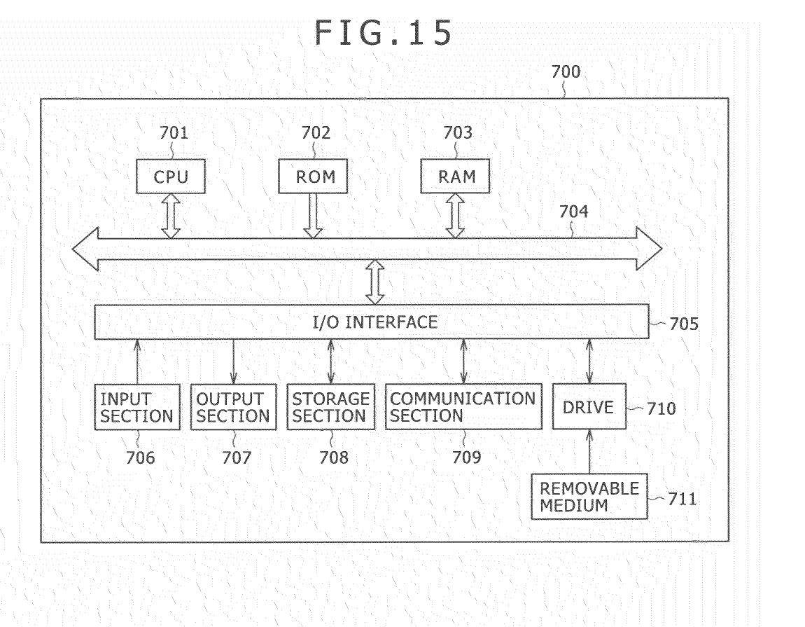

It should be noted that the above series of processes may be performed by hardware or software. If the series of processes are performed by software, the program making up the software is installed from a network or recording medium to a computer incorporated in dedicated hardware. Alternatively, the program is installed from a network or recording medium to, for example, a general-purpose personal computer 700 as illustrated in FIG. 15 capable of performing various functions when installed with various programs.

In FIG. 15, a CPU (Central Processing Unit) 701 performs various processes according to the program stored in a ROM (Read Only Memory) 702 or loaded from a storage section 708 into a RAM (Random Access Memory) 703. The RAM 703 also stores, as appropriate, data required for the CPU 701 to perform various processes.

The CPU 701, ROM 702 and RAM 703 are connected to each other via a bus 704. An I/O interface 705 is also connected to the bus 704.

An input section 706 and output section 707 are connected to the I/O interface 705. The input section 706 includes, for example, a keyboard and mouse. The output section 707 includes, for example, a display and speaker. The display includes, for example, an LCD (Liquid Crystal Display). Further, a storage section 708 and communication section 709 are connected to the I/O interface 705. The storage section 708 includes, for example, a harddisk. The communication section 709 includes, for example, a network interface card such as modem or LAN card. The communication section 709 communicates via networks including the Internet.

A drive 710 is also connected, as necessary, to the I/O interface 705. A removable medium 711 such as magnetic disk, optical disk, magneto-optical disk or semiconductor memory is inserted into the drive 710 as appropriate. The computer program read out from the removable medium is installed to the storage section 708 as necessary.

If the series of processes are performed by software, the program making up the software is installed from a network such as the Internet or from a recording medium such as the removable medium 711.

It should be noted that this recording medium includes those including the removable medium 711 such as a magnetic disk (including floppy disk (registered trademark)), optical disk (including CD-ROM (Compact Disk-Read Only Memory) and DVD (including Digital Versatile Disk)) and magneto-optical disk (MD (Mini-Disk) (registered trademark)), that are distributed separately from the data reader itself shown in FIG. 15 for delivery of the program to users, or those made up of the removable medium 711 that is, in turn, made up of a semiconductor memory or other memory. This recording medium also includes others including the ROM 702, in which the program is stored, and the harddisk, contained in the storage section 708, that are incorporated in advance in the data reader itself and delivered to users.

It should be noted that the steps adapted to perform the series of processes described above in the present specification include not only those processes performed chronologically according to the described sequence but also others that are not necessarily performed chronologically but concurrently or individually.

On the other hand, the embodiments of the present invention are not limited to the above, but may be modified in various manners without departing from the spirit and scope of the present invention.

The present application contains subject matter related to that disclosed in Japanese Priority Patent Application JP 2010-022373 filed in the Japan Patent Office on Feb. 3, 2010, the entire content of which is hereby incorporated by reference.

What is claimed is:

1. A data reader comprising:
image acquisition means operable to acquire an image having color cells arranged in a two-dimensional space, each of the color cells being made up of a graphic of a given color density in a predetermined form and size;
spatial deinterleaving means operable to perform spatial deinterleaving adapted to sort the color cells arranged in the two-dimensional space in a spatially distributed manner in the acquired image; and
color decoding means operable to decode data coded in association with colors of the color cells and densities of the colors by analyzing the image with the sorted color cells as color data associated with coordinate positions in the two-dimensional space.

2. The data reader of claim 1, wherein
the spatial deinterleaving means sorts the color cells arranged in a spatially distributed manner through hierarchical random interleaving.

3. The data reader of claim 1, wherein
the color data associated with the coordinate positions in the two-dimensional space is multiplexed data obtained by multiplexing a plurality of data elements, and
the color decoding means separates the multiplexed data into the data elements.

4. The data reader of claim 3, wherein
the plurality of data elements are multiplexed by dividing the two-dimensional space in which the image is displayed.

5. The data reader of claim 3, wherein
the plurality of data elements are multiplexed with frequencies associated with changes in color of the color cells in the two-dimensional space in which the image is displayed.

6. The data reader of claim 3, wherein
the plurality of data elements are multiplexed by combining a plurality of colors on the same color cell.

7. The data reader of claim 1 further comprising:
control information decoding means operable to decode control information made up of a graphic in a predetermined color, form and size that is displayed at a predetermined position of the two-dimensional space in which the image is displayed, wherein
the deinterleaving and color decoding are performed based on information contained in the control information.

8. The data reader of claim 1 further comprising:
equalization means operable to perform equalization adapted to correct the colors of the color cells based on the color of a pilot made up of a graphic in a predetermined color, form and size that is displayed at a predetermined position of the two-dimensional space in which the image is displayed.

9. A data reading method comprising the steps of:
using image acquisition means to acquire an image having color cells arranged in a two-dimensional space, each of the color cells being made up of a graphic of a given color density in a predetermined form and size;
using spatial deinterleaving means to perform spatial deinterleaving adapted to sort the color cells arranged in the two-dimensional space in a spatially distributed manner in the acquired image; and
using color decoding means to decode data coded in association with colors of the color cells and densities of the colors by analyzing the image with the sorted color cells as color data associated with coordinate positions in the two-dimensional space.

10. A program causing a computer to function as a data reader, the data reader comprising:
image acquisition means operable to acquire an image having color cells arranged in a two-dimensional space, each of the color cells being made up of a graphic of a given color density in a predetermined form and size;
spatial deinterleaving means operable to perform spatial deinterleaving adapted to sort the color cells arranged in the two-dimensional space in a spatially distributed manner in the acquired image; and
color decoding means operable to decode data coded in association with colors of the color cells and densities of the colors by analyzing the image with the sorted color cells as color data associated with coordinate positions in the two-dimensional space.

11. A data recorder comprising:
color coding means operable to code input digital data in association with colors and densities of the colors;
spatial interleaving means operable to perform spatial interleaving adapted to sort data, coded in association with the colors and color densities, in a spatially distributed manner during arrangement of the data in a two-dimensional space; and
recording means operable to record the input digital data by displaying the spatially interleaved data as color cells in the two-dimensional space, each of the color cells being made up of a graphic of a given color density in a predetermined form and size.

12. A data reader comprising:
image acquisition means operable to acquire an image having color cells arranged in a two-dimensional space, each of the color cells being made up of a graphic of a given color density in a predetermined form and size;
equalization means operable to perform equalization adapted to correct the colors of the color cells based on the color of a pilot made up of a graphic in a predetermined color, form and size that is displayed at a predetermined position of the two-dimensional space in which the image is displayed; and
color decoding means operable to decode data coded in association with colors of the color cells and densities of the colors by analyzing the image with the corrected colors of the color cells as color data associated with coordinate positions in the two-dimensional space.

13. The data reader of claim 12, wherein
the color data associated with the coordinate positions in the two-dimensional space is multiplexed data obtained by multiplexing a plurality of data elements, and
the color decoding means separates the multiplexed data into the data elements.

14. The data reader of claim 13, wherein
the plurality of data elements are multiplexed by dividing the two-dimensional space in which the image is displayed.

15. The data reader of claim 13, wherein
the plurality of data elements are multiplexed with frequencies associated with changes in color of the color cells in the two-dimensional space in which the image is displayed.

16. The data reader of claim 13, wherein
the plurality of data elements are multiplexed by combining the plurality of color cell colors.

17. The data reader of claim 12 further comprising
control information decoding means operable to decode control information made up of a white or black graphic in a predetermined form and size that is displayed at a predetermined position of the two-dimensional space in which the image is displayed, wherein
the equalization and color decoding are performed based on information contained in the control information.

18. A data reading method comprising the steps of:
using image acquisition means to acquire an image having color cells arranged in a two-dimensional space, each of the color cells being made up of a graphic of a given color density in a predetermined form and size;
using equalization means to perform equalization adapted to correct the colors of the color cells based on the color of a pilot made up of a graphic in a predetermined color, form and size that is displayed at a predetermined position of the two-dimensional space in which the image is displayed; and
using color decoding means to decode data coded in association with colors of the color cells and densities of the colors by analyzing the image with the corrected colors of the color cells as color data associated with coordinate positions in the two-dimensional space.

19. A program causing a computer to function as a data reader, the data reader comprising:
image acquisition means operable to acquire an image having color cells arranged in a two-dimensional space, each of the color cells being made up of a graphic of a given color density in a predetermined form and size;
equalization means operable to perform equalization adapted to correct the colors of the color cells based on the color of a pilot made up of a graphic in a predetermined color, form and size that is displayed at a predetermined position of the two-dimensional space in which the image is displayed; and
color decoding means operable to decode data coded in association with colors of the color cells and densities of the colors by analyzing the image with the corrected colors of the color cells as color data associated with coordinate positions in the two-dimensional space.

20. A data recorder comprising:
color coding means operable to code input digital data in association with colors and densities of the colors;
pilot insertion means operable to insert data of a pilot into the coded data so that the pilot, displayed at a predetermined coordinate position as a graphic of a given color density in a predetermined form and size, is inserted during arrangement of an image of the color densities in a two-dimensional space based on the coded data; and
recording means operable to record the input digital data by displaying, in the two-dimensional space, the coded data having the data of the pilot inserted thereinto as an image that includes color cells and the pilot, each of the color cells being made up of a graphic of a given color density in a predetermined form and size.

21. A data reader comprising:
an image acquisition section configured to acquire an image having color cells arranged in a two-dimensional space, each of the color cells being made up of a graphic of a given color density in a predetermined form and size;
a spatial deinterleaving section configured to perform spatial deinterleaving adapted to sort the color cells arranged in the two-dimensional space in a spatially distributed manner in the acquired image; and
a color decoding section configured to decode data coded in association with colors of the color cells and densities of the colors by analyzing the image with the sorted color cells as color data associated with coordinate positions in the two-dimensional space.

22. A data recorder comprising:
a color coding section configured to code input digital data in association with colors and densities of the colors;
a spatial interleaving section configured to perform spatial interleaving adapted to sort data, coded in association with the colors and color densities, in a spatially distributed manner during arrangement of the data in a two-dimensional space; and
a recording section configured to record the input digital data by displaying the spatially interleaved data as color cells in the two-dimensional space, each of the color cells being made up of a graphic of a given color density in a predetermined form and size.

23. A data reader comprising:
an image acquisition section configured to acquire an image having color cells arranged in a two-dimensional space, each of the color cells being made up of a graphic of a given color density in a predetermined form and size;
an equalization section configured to perform equalization adapted to correct the colors of the color cells based on the color of a pilot made up of a graphic in a predetermined color, form and size that is displayed at a predetermined position of the two-dimensional space in which the image is displayed; and
a color decoding section configured to decode data coded in association with colors of the color cells and densities of the colors by analyzing the image with the corrected colors of the color cells as color data associated with coordinate positions in the two-dimensional space.

24. A data recorder comprising:
a color coding section configured to code input digital data in association with colors and densities of the colors;
a pilot insertion section configured to insert data of a pilot into the coded data so that the pilot, displayed at a predetermined coordinate position as a graphic of a given color density in a predetermined form and size, is inserted during arrangement of an image of the color densities in a two-dimensional space based on the coded data; and
a recording section configured to record the input digital data by displaying, in the two-dimensional space, the coded data having the data of the pilot inserted thereinto as an image that includes color cells and the pilot, each of the color cells being made up of a graphic of a given color density in a predetermined form and size.
